(19) United States
(12) Patent Application Publication
(10) Pub. No.: US 2011/0178239 A1
(43) Pub. Date: Jul. 21, 2011

(54) USE OF SUBSTITUTED 2-ARYL-2-ALKYL-1,3-PROPANEDIOLS OR SUBSTITUTED 2-CYCLOHEXYL-2-ALKYL-1,3-PROPANEDIOLS FOR MANUFACTURING POLYMERS

(75) Inventors: Darijo Mijolovic, Mannheim (DE); Sebastien Garnier, Weinheim (DE); Qiang Miao, Mannheim (DE); Maria Guixa Guardia, Mannheim (DE); Gerd-Dieter Tebben, Mannheim (DE)

(73) Assignee: BASF SE, Ludwigshafen (DE)

(21) Appl. No.: 13/061,743

(22) PCT Filed: Aug. 24, 2009
(86) PCT No.: PCT/EP2009/060851

§ 371 Date: Mar. 2, 2011

(30) Foreign Application Priority Data
Sep. 4, 2008 (EP) 08163682.1

(51) Int. Cl. C09D 167/02; C08G 63/19; C08G 63/199

(52) U.S. Cl. 524/605; 528/305; 528/302; 524/604

(57) ABSTRACT

Polymer obtainable by polycondensation or polyadduct formation from monomeric compounds, wherein accompanying use is made as monomeric compound of

substituted 2-aryl-2-alkyl-1,3-propanediols of the formula I or substituted 2-cyclohexyl-2-alkyl-1,3-propanediols of the formula Ia

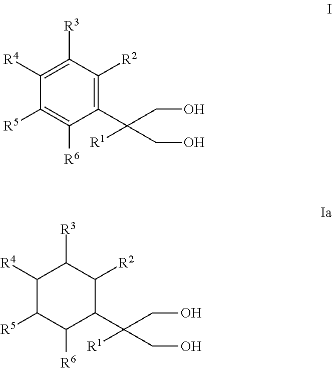

or the alkoxylated derivatives of the formula I or of the formula Ia.

The invention relates to a polymer which is obtainable by polycondensation or polyadduct formation from monomeric compounds, wherein accompanying use is made as monomeric compound of

substituted 2-aryl-2-alkyl-1,3-propanediols of the formula I or substituted 2-cyclohexyl-2-alkyl-1,3-propanediols of the formula Ia

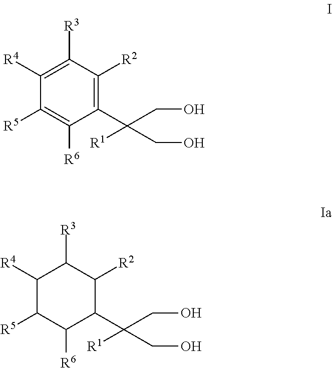

or the alkoxylated derivatives of the compounds of the formulae I and Ia.

Diols are needed for the preparation of polymers, examples being polyesters or polyurethanes. The use of neopentyl glycol is described in Ullmanns Encyclopedia of Industrial Chemistry “Alcohols, Polyhydric” by Peter Werle et al. page 4-6.

In EP-A 562 578, for example, the use of various cyclohexanediols such as 1,4-cyclo-hexanedimethanol or 1,4-cyclohexanediethanol in the preparation of polyesters is described.

The use of 2-pentyl-2-propyl-1,3-propanediol for the preparation of polyesters is known from JP HEI 03-161452.

DE-A 1009915 describes the preparation of 2-methyl-2-phenyl-1,3-propanediol by means of a Cannizzaro reaction. BE-A 629257 as well describes the synthesis of 2-cyclohexyl-2-methyl-1,3-propanediol by a Cannizzaro reaction. Neither of these patents, however, describes the use of 2-cyclohexyl-2-methyl-1,3-propanediol or 2-methyl-2-phenyl-1,3-propanediol for preparing polymers.

The 1,3-propanediols can also, however, be obtained alternatively by aldol reaction, as described in WO 01/51438, WO 97/17313 or WO 98/29374, of the corresponding carbaldehydes with formaldehyde and by subsequent hydrogenation, as described in EP-A 44412 or EP-A 44444, of the resultant 2-hydroxymethylaldehydes.

Alternatively the compounds of the formula Ia can also be prepared by hydrogenation of the compounds of the formula I.

There is a fundamental desire to improve the performance properties of polymers in the context of their various uses.

When the polymers are used as binders in coating materials, adhesives or sealants, the glass transition temperature is of particular importance. For film-forming applications, the coatings produced are to have good mechanical properties, such as impact toughness and elasticity, high scratch resistance and impact resistance, high resistances to water, solvents, grease and chemicals and also a high gloss.

It was an object of the present invention to provide such polymers.

This object is achieved by means of a polymer obtainable by polycondensation or polyadduct formation from monomeric compounds, wherein use is made as monomeric compound of

substituted 2-aryl-2-alkyl-1,3-propanediols of the formula I or substituted 2-cyclohexyl-2-alkyl-1,3-propanediols of the formula Ia

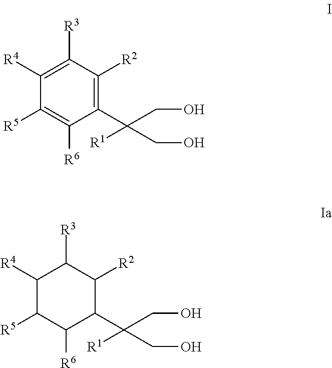

or the alkoxylated derivatives of the compounds of the formulae I and Ia, where R¹ is a linear or branched alkyl group having 1 to 10 C atoms and R² to R⁶ independently of one another are selected from the group consisting of hydrogen, methyl-, ethyl-, propyl-, isopropyl-, n-butyl-, and tert-butyl-.

Advantageously, in the polymer of the invention, use is made as monomeric compound or its alkoxylated derivatives of the formula I or of the formula Ia of those for which R¹ is linear alkyl groups having 1 to 4 C atoms and R² to R⁶ is hydrogen.

Advantageously, in the polymer of the invention, the compounds of the formula I or of the formula Ia are obtainable by reacting aldehydes of the formula II or of the formula IIa

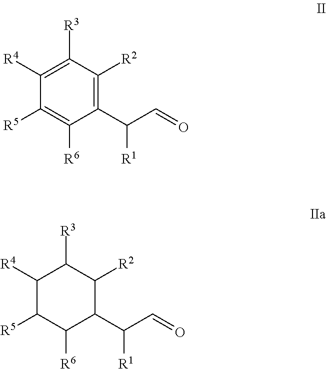

where R¹ to R⁶ have the preceding definitions with formaldehyde in an aldol-Cannizzaro reaction or in an aldol condensation with subsequent hydrogenation.

Advantageously the polymer of the invention is a polymer wherein the compounds of the formula Ia are obtainable by hydrogenating corresponding, identically substituted compounds of the formula I, where R¹ and R² to R⁶ have the preceding definition.

Advantageously, in the polymer of the invention, the polymer is a polyester.

Advantageously, in the polymer of the invention, the polymer is a polycarbonatediol (obtainable by reacting dialkyl carbonates or cyclic carbonates with diols, with elimination of alcohol).

Advantageously, in the polymer of the invention, the polymer is a polyurethane.

Advantageously, in the polymer of the invention, the polymer is a polyadduct which is obtainable by ring-opening addition polymerization of lactones or lactams.

The invention further provides for the use of the polymer of the invention for preparing a thermoplastic composition.

The invention further provides thermoplastic compositions comprising a polymer of the invention and/or repeat units of a polymer of the invention.

The invention further provides for the use of the thermoplastic compositions of the invention for producing shaped articles.

The invention further provides for the use of the polymer of the invention for preparing coating materials, sealants or adhesives.

The invention further provides coating materials, sealants or adhesives comprising repeat units of a polymer of the invention.

The coating materials, sealants or adhesives of the invention are advantageously aqueous materials.

The invention further provides for the use of a polymer of the invention for producing powder coating materials.

The invention further provides a powder coating material comprising repeat units of a polymer of the invention.

The invention further provides for the use of the polymer of the invention for producing radiation-curable coating materials.

The invention further provides radiation-curable coating materials comprising repeat units of a polymer of the invention.

The polymers of the invention are prepared using compounds of the formula I or of the formula Ia or the alkoxylated derivatives of the formula I or of the formula Ia in which R¹ is a linear or branched alkyl chain having 1 to 10 C atoms and R² to R⁶ independently of one another are selected from the group consisting of hydrogen, methyl-, ethyl-, propyl-, isopropyl-, n-butyl-, and tert-butyl-. With particular preference R¹ is a linear alkyl group having 1 to 4 C atoms; with very particular preference R¹ is a methyl group. With particular preference R² to R⁶ are hydrogen. Particularly preferred compounds of the formula I and Ia are 2-methyl-2-phenyl-1,3-propanediol and 2-cyclohexyl-2-methyl-1,3-propanediol.

The alkoxylated derivatives of the compound of the general formula I or of the formula Ia are products of the reaction with one or with a mixture of alkylene oxides. Examples of alkylene oxides are ethylene, propylene, n-butylene, isobutylene, styrene or cyclohexene oxides. More particularly the aforementioned diols are ethoxylated and propoxylated. The alkoxylation products are obtainable in a known way by reaction of the above alcohols with alkylene oxides, especially ethylene oxide or propylene oxide. The degree of alkoxylation per hydroxyl group is preferably 0 to 20, more particularly 0 to 10, i.e., 1 mol of hydroxyl group may be alkoxylated preferably with up to 20 mol, more particularly 10 mol, of alkylene oxides.

In one preferred embodiment the compounds of the formula I or of the formula Ia are not alkoxylated.

The compounds of the formula I or of the formula Ia are obtained by a Cannizzaro reaction of the corresponding aldehydes of the formula II or formula IIa with formaldehyde. The process for preparing 2-phenyl-2-methyl-1,3-propanediol and 2-cyclohexyl-2-methyl-1,3-propanediol has already been described in DE-A 1009915 and BE-A 629257. Furthermore, compounds of the formula I or formula Ia may be obtained by aldol reaction of the corresponding aldehydes of the formula II or of the formula IIa with formaldehyde, followed by a hydrogenation. The aldol reaction is described, for example, in WO 01/51438, WO 97/17313 or WO 98/29374. The hydrogenation can be carried out by analogy with the disclosure in EP-A 44412 or EP-A 44444.

As an alternative to these processes, the compound of the formula IIa can also be prepared by hydrogenation of the compound of the formula II.

Alternatively to these processes, the compound Ia may be prepared by hydrogenating the compound of the formula I, where the compound I may be prepared by one of the above processes.

### The Polymers

The polymers are obtainable by polycondensation or polyadduct formation from monomeric compounds with accompanying use of one or more compounds of the formula I or of the formula Ia; the polymers can, if desired, be chemically modified—for example, functionalized or crosslinked—by other or further reactions.

When monomeric compounds are subjected to polycondensation, there is elimination of water or alcohol; in the case of polyadduct formation there is no elimination.

Preferred polycondensates are polyesters, which are obtainable by reacting diols or polyols with dicarboxylic or polycarboxylic acids, which can also be used in the form of reactive derivatives, such as anhydrides or esters.

The term polyester is intended below to refer to a polymer which is composed to an extent of more than 50%, more preferably more than 70%, and more particularly more than 90% by weight of synthesis components selected from diols, polyols, dicarboxylic acids and polycarboxylic acids.

Mention may also be made of polycarbonatediols, which are obtainable by reacting dialkyl carbonates or cyclic carbonates with diols, with elimination of alcohols.

As a polyadduct, mention may be made in particular of polyurethane. In particular it is possible for polyurethanes also to comprise repeat units of polymers of the invention. Also contemplated, for example, are polyadducts, which are obtainable by ring-opening addition polymerization of lactones or lactams.

The term polyurethane is intended below to refer to a polymer which is composed to an extent of more than 50%, more preferably more than 70%, and more particularly more than 90% by weight of synthesis components selected from diisocyanates, polyisocyanates, diols and polyols.

All of these polymers share the feature that they are synthesized substantially from diols and from compounds that are reactive with these diols, such as di- and/or polycarboxylic acids (polyesters) or di- and/or polyisocyanates (polyurethanes).

Preferred polymers are polyesters and polyurethanes; polyesters are particularly preferred.

The polymers of the invention preferably have the below-stated content of the monomer units of the compounds of the formula I or of the formula Ia or alkoxylated derivatives thereof. The below-stated weight figures relating to the amount of the compounds of the formula I or of the formula Ia or alkoxylated derivatives thereof in the polymer refer in this case to the units of the polymer that derive from compounds of the formula I or of the formula Ia or their alkoxylated compounds. In the case of polyadducts, the weight of these units corresponds directly to the compound of the formula I or of the formula Ia or alkoxylated derivatives thereof; in the case of polycondensates, the weight of these units is reduced in value by the weight of the hydrogen atoms of the hydroxyl groups.

Preferred polymers are composed to an extent of at least 0.5%, more preferably at least 2%, very preferably at least 5%, and more particularly at least 10% by weight and in one particular embodiment at least 20% by weight, of compounds of the formula I or of the formula Ia or their alkoxylated derivatives. Since the accompanying use of other compounds reactive with the diols is mandatory, the polymers are generally composed to an extent of not more than 90%, more particularly not more than 60%, or not more than 50%, by weight, of the compounds of the formula I or of the formula Ia or their alkoxylated derivatives.

Besides the compounds of the formula I or of the formula Ia or their alkoxylated derivatives, the polymers may also comprise other diols or polyols as synthesis components. In one preferred embodiment at least 10%, more preferably at least 25%, and very preferably at least 50% by weight of the diols and polyols of which the polymers are composed comprise the compounds of the formula I or of the formula Ia or their alkoxylated derivatives.

More particularly at least 70% by weight or at least 90% by weight of the diols and polyols, of which the polymers are composed may comprise the compounds of the formula I or of the formula Ia or their alkoxylated derivatives.

In one particular embodiment 100% by weight of all the diols and polyols of which the polymers are composed may comprise a single compound of the formula I or of the formula Ia or a mixture of compounds of the formula I or of the formula Ia or their alkoxylated derivatives.

### Further Constituents of the Polyesters

Polyesters, besides the compounds of the formula I or their alkoxylated derivatives, may comprise further diols or polyols as synthesis components.

Examples of further diols include ethylene glycol, propylene glycol and their counterparts with higher degrees of condensation, such as, for example, diethylene glycol, triethylene glycol, dipropylene glycol, tripropylene glycol etc., 2-methyl-1,3-propanediols, butanediols, pentanediols, hexanediols, neopentyl glycol, alkoxylated phenolic compounds, such as ethoxylated and/or propoxylated bisphenols, and cyclohexanedimethanol. Further suitable polyols are trifunctional and higher polyfunctional alcohols, such as glycerol, trimethylolpropane, butanetriol, trimethylolethane, pentaerythritol, ditrimethylolpropane, dipentaerythritol, sorbitol, and mannitol.

Preferred mixtures of the compounds of the formula I or of the formula Ia with a diol and a triol are mixtures of 2-methyl-2-phenyl-1,3-propanediol or 2-cyclohexyl-2-methyl-1,3-propanediol with neopentyl glycol and trimethylolpropane.

The above diols or polyols may be alkoxylated, more particularly ethoxylated and propoxylated. The alkoxylation products are obtainable in a known way by reaction of the above alcohols with alkylene oxides, especially ethylene oxide or propylene oxide. The degree of alkoxylation per hydroxyl group is preferably 0 to 20, i.e., 1 mol of hydroxyl group may be alkoxylated preferably with up to 20 mol of alkylene oxides.

The polyesters further comprise dicarboxylic acids or polycarboxylic acids as synthesis components. In the preparation of the polyesters, dicarboxylic acids or polycarboxylic acids may also be used in the form of their reactive derivatives, e.g. as anhydrides or esters. Suitable dicarboxylic acids are succinic acid, glutaric acid, adipic acid, sebacic acid, isophthalic acid, terephthalic acid, their isomers and hydrogenation products, such as tetrahydrophthalic acid. Also contemplated are maleic acid and fumaric acid for unsaturated polyesters.

Polyesters may also comprise monoalcohols or monocarboxylic acids as a constituent; through accompanying use of compounds of this kind it is possible to adjust or limit the molecular weight.

In order for particular properties to be achieved the polyesters may comprise particular functional groups. Water-soluble or water-dispersible polyesters comprise the necessary amount of hydrophilic groups, carboxyl groups or carboxylate groups, for example, to achieve solubility in water or dispersibility in water. Crosslinkable polyesters, for powder coating materials, for example, comprise functional groups, which enter into a crosslinking reaction with the crosslinking agent that is used. These may likewise be carboxylic acid groups, if crosslinking is intended with compounds comprising hydroxyl groups, hydroxyalkylamides, for example. The functional groups may also be ethylenically unsaturated groups, through modification of the polyester with unsaturated dicarboxylic acids (maleic acid) or reaction with (meth)acrylic acid, for example. Polymers of this kind are radiation-curable or crosslinkable chemically or thermally.

Unsaturated polyesters may also be copolymerized with free-radically polymerizable compounds that contain single or else multiple ethylenic unsaturation, such as styrene, C₁-C₁₀ alkyl acrylates, dialkyl acrylates, e.g., the diacrylate of ethanediol or butanediol. For this purpose, the unsaturated polyester may be used in a mixture with the ethylenically unsaturated monomers, as described in WO 00/23495 and EP 1131372, for example. In this case the above ethylenically unsaturated compounds serve simultaneously as solvents (reactive diluents), and so the mixture is present preferably as a solution of the polyesters in these compounds. The mixture may be used, for example as a coating or impregnating composition, including in particular its use for producing laminates. Curing may take place thermally or photochemically, in both cases also optionally with addition of an initiator. Such compounds, which can be cured chemically, thermally or by UV radiation, are also called thermosets.

### Further Constituents of the Polyurethanes

Polyurethanes comprise di- or polyisocyanates as an essential synthesis component.

Particular mention is made of diisocyanates Y(NCO)2, where Y is an aliphatic hydrocarbon radical having 4 to 15 C atoms, a cycloaliphatic or aromatic hydrocarbon radical having 6 to 15 C atoms or an araliphatic hydrocarbon radical having 7 to 15 C atoms. Examples of diisocyanates of this kind are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis and the cis/trans isomers, and mixtures of these compounds.

Diisocyanates of this kind are available commercially.

Particularly important mixtures of these isocyanates are the mixtures of the respective structural isomers of diisocyanatotoluene and diisocyanatodiphenylmethane; a particularly suitable mixture is that of 80 mol % of 2,4-diisocyanatotoluene and 20 mol % 2,6-diisocyanatotoluene. Also particularly advantageous are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, the preferred mixing ratio of aliphatic to aromatic isocyanates being 4:1 to 1:4.

As diols and/or polyols, which are reacted with the di- or polyisocyanates, the invention uses compounds of the general formula I or of the formula Ia as pure compounds or as mixtures of compounds of the general formula I or of the formula Ia or their alkoxylated derivatives or in a mixture with other diols or polyols. As diols and/or polyols it is also possible more particularly to use polymers of the invention.

In the case of polyurethanes, it is also preferred to use polyester diols and/or polyester polyols as diols and/or polyols. They are referred to in general below as polyesterols. Such polyesterols are obtained beforehand by reacting diols or polyols with dicarboxylic or polycarboxylic acids (see above description of the polyesters). The compounds of the general formula I or of the formula Ia or mixtures of compounds of the general formula I or of the formula Ia or their alkoxylated derivatives may be comprised in the polyurethanes in the form of such polyesterols. Further diols and polyols contemplated are those mentioned above, either as synthesis components which are reacted directly with the di- or polyisocyanates, or as a constituent of the polyesterols. Suitable dicarboxylic acids or polycarboxylic acids for the polyesterols are likewise those mentioned above.

The polyurethanes may also comprise monoalcohols or monoisocyanates as constituents; by accompanying use of such compounds it is possible to adjust or limit the molecular weight.

In order to achieve particular properties, the polyurethanes may comprise particular functional groups. Water-soluble or water-dispersible polyurethanes comprise the necessary amount of hydrophilic groups-carboxyl groups or carboxylate groups, for example—to achieve solubility in water or dispersibility in water. An example of a suitable synthesis component is dimethylolpropionic acid. Crosslinkable polyurethanes comprise functional groups, which enter into a crosslinking reaction with the crosslinking agent that is used. Beside urethane groups, the polyurethanes may more particularly also comprise other functional groups, urea groups, for example, which form through reaction of the di- or polyisocyanates with amino compounds. The polymers may, if desired, be chemically modified—for example, functionalized or crosslinked—by other or further reactions during preparation or else, in particular, at a later point in time, as for example in the course of their use.

In particular the polymers may comprise crosslinking groups which, as soon as the necessary conditions are present, enter into a crosslinking reaction. The polymers may, in particular, also be used in a mixture with crosslinkers which at the desired point in time, and under the necessary conditions (more particularly at an elevated temperature), enter into a crosslinking reaction with the polymer, forming thermosets.

According to the reactivity of the crosslinkers, a distinction is made between one-component (1K) and two-component (2K) systems. In the case of 2K systems, the crosslinker is not added until shortly before the subsequent use; in the case of 1K systems, the crosslinker may be added to the system at an early stage (latent crosslinker), with crosslinking occurring only under the conditions that are brought about later on, such as during the removal of solvents and/or during an increase in temperature, for example.

Typical crosslinkers are, for example, isocyanates, epoxides, acid anhydrides or else—in the case of polymers having free-radically polymerizable ethylenically unsaturated groups—ethylenically unsaturated monomers such as styrene.

### The Use of the Polymers

The polymers are suitable for use as a constituent of thermoplastic compositions. The polymers, polyesters or polyurethanes, for example, have for this purpose, preferably a sufficiently high molecular weight to give them thermoplastic properties.

Thermoplastic compositions are generally used for producing shaped articles, in which context it is possible to employ customary methods such as injection molding, extrusion or blow molding.

More particularly the polymers are suitable for use as a constituent of coating materials, sealants or adhesives.

The coating materials, sealants or adhesives comprise the polymers of the invention preferably as binders. They may comprise further binders and other additives, examples being antioxidants, stabilizers, dyes, pigments, flow control assistants, thickeners, or wetting assistants.

The coating materials, sealants or adhesives may be aqueous or solvent borne materials. Aqueous materials are preferred. Materials of this kind comprise the binders of the invention preferably in the form of solutions or dispersions in water or organic solvents or mixtures thereof. Where necessary, the polymers comprise additional functional groups which produce solubility or dispersibility in water or organic solvents, preferably in water (see above).

The coating materials, sealants or adhesives may also be materials which are largely free of water or organic solvents (known as 100% systems). Materials of this kind generally comprise less than 10 parts by weight of water or other organic solvents (boiling point less than 150° C. at 1 bar), per 100 parts by weight of the materials. With particular preference they comprise less than 2 parts by weight, very preferably less than 1 part by weight, or less than 0.5 part by weight of water or other organic solvents (boiling point less than 150° C. at 1 bar), per 100 parts by weight of the materials.

The materials in question may be materials which are still fluid at room temperature or may be materials which are present in the form, for example, of a powder and which are processed only at elevated temperatures.

The materials, especially coating materials, may be radiation-curable or used as radiation-curable materials or coating materials, which are referred to as thermosets. For that purpose they preferably comprise a radiation-curable polymer of the invention, more particularly a radiation-curable polyester (see above). The radiation curing may take place with high-energy radiation, electron beams, for example, or UV light; when UV light is used, it is possible with preference to add a photoinitiator to the polymers.

One preferred use in the context of the present invention is the use of the polymers of the invention as or in powder coating materials. As powder coating material which is crosslinkable it is preferred to use polyesters.

In one preferred embodiment the powder coating material is prepared by mixing and melting the polyester, crosslinker and further additives, pigments and flow control agents, for example, at high temperatures. The mixture can be brought into powder form by subsequent extrusion and corresponding processing of the extrudate.

The powder coating material may be coated onto the desired substrates, examples being those with surfaces of metal, plastic or wood, in a conventional manner, including, for example, electrostatically.

The polymers of the invention have a heightened glass transition temperature. Furthermore, they have a very good resistance to hydrolysis.

When used in coating materials, sealants and adhesives, the polymers of the invention produce good mechanical properties; in particular the coating materials, powder coating materials, for example, have high impact toughness, good elasticity and high gloss.

### EXAMPLES

### Abbreviations

ADA: adipic acid
CHMPD: 2-cyclohexyl-2-methyl-1,3-propanediol
D: polydispersity index (M_{w}/Mₙ)
DPG: dipropylene glycol
DBTO: dibutyltin oxide
DSC: differential scanning calorimetry
GPC: gel permeation chromatography
IPA: isophthalic acid
Mₙ: number-average molecular weight in [g/mol]
M_{w}: weight-average molecular weight in [g/mol]
MPPD: 2-methyl-2-phenylpropane-1,3-diol
NVC: nonvolatiles content
NPG: neopentyl glycol
OHN: OH number
AN: acid number
T_{g}: glass transition temperature
TMP: trimethylolpropane
TMA: trimellitic anhydride
TPA: terephthalic acid
η₁: melt viscosity
n₂: solution viscosity

### Polymer Characterization Methods

The molecular weight determinations are carried out by GPC. Stationary phase: highly crosslinked porous polystyrene-divinylbenzene, available commercially as PL-GEL from Polymer Laboratories. Mobile phase: THF. Flow rate: 0.3 ml/min. Calibration with polyethylene glycol 28700 to 194 daltons from PSS.

The acid number of the polyesters is determined in accordance with the DIN standard method 53169.

The melt viscosity η₁ of the polyesters is determined using a cone/plate viscometer at 160° C. in oscillation mode and is carried out with an angular velocity of 0.1 rad/s. The solution viscosity η₂ of the polyesters is determined using a cone/plate viscometer at room temperature in rotation mode. The solutions consist of 70% polyester and 30% 5:1 alkylbenzene/methylpropylene glycol-based solvent (5/1 mixture of Solvesso 100™/Solvenon PM™).

The Tg of the polyesters is determined by means of DSC in accordance with ASTM D3418.

Preparation of Powder Polyesters with COOH Groups

### Polyester P1

### Stage I—Preparation of the OH-Containing Oligomer

121.3 g of MPPD (0.73 mol), 253.5 g of NPG (2.44 mol), 14.1 g of TMP (0.11 mol), 424.6 g of TPA (2.56 mol), and 0.4 g of DBTO catalyst are charged to a 2 l four-neck flask fitted with thermometer, inert gas inlet, stirrer and reflux condenser. Under reflux, with a stream of nitrogen being passed through, the mixture of reactants is heated rapidly to 180° C. Water is distilled off continuously. Subsequently the reaction mixture is heated in stages to 230° C. over the course of 3 to 5 h with stirring and with flow of nitrogen, and is stirred further at 230° C. until the oligomer has an AN of 10 to 15 mg KOH/g. The AN of the oligomer is 12 mg KOH/g.

### Stage II—Preparation of the COOH-Containing Polymer P1

The oligomer synthesized above is cooled to 180° C. and then 182.0 g of IPA (1.10 mol) are added. The temperature is raised to 230° C., and condensation is continued under these conditions until the polymer has an AN of 50±4 mg KOH/g. The water formed from the polymerization can be stripped off at the end of the reaction by a gentle vacuum, in order to achieve the desired AN. This gives a branched COOH-containing powder polyester P1, whose AN is 46 mg KOH/g. P1 has a glass transition temperature T_{g} of 80° C. and a melt viscosity η₁ of 89.8 Pa*s at 160° C. The GPC analysis yields the following values: Mₙ=2010 g/mol; D=3.8 (see Table 1).

### Polyesters P2 to P5

The procedure is the same as for the preparation of P1, with the compositions summarized in Table 1. This gives branched COOH-containing powder polyesters, whose characteristic data AN, Mₙ, D, T_{g} and η₁ are listed in Table 1.

P2 Example 2

P3 Comparative example 3

P4 Example 4

P5 Comparative example 5

TABLE 1

| | Composition | | | | | | Characteristic polyester data | | | | |
|---|---|---|---|---|---|---|---|---|---|---|---|
| | MPPD | CHMPD | NPG | TMP | TPA | IPA | AN | Mₙ | | T_{g} | η₁ |
| Polyester | [g] | [g] | [g] | [g] | [g] | [g] | [mg KOH/g] | [g/mol] | D | [° C.] | [Pa*s] |
| P1 | 121.3 | 0 | 253.5 | 14.1 | 424.6 | 182.0 | 46 | 2010 | 3.8 | 80 | 90 |
| P2 | 0 | 125.1 | 252.2 | 14.1 | 422.4 | 181.0 | 52 | 2110 | 5.2 | 80 | 106 |
| P3 | 0 | 0 | 396.0 | 17.0 | 510.3 | 218.7 | 49 | 2100 | 2.8 | 73 | 39 |
| P4 | 137.0 | 0 | 300.9 | 13.8 | 479.9 | 205.7 | 37 | 2550 | 3.6 | 80 | 140 |
| P5 | 0 | 0 | 407.9 | 14.6 | 506.1 | 216.9 | 38 | 2400 | 3.2 | 73 | 54 |

The polymers P1, P2 and P4 of the invention have a markedly higher glass transition temperature than the corresponding comparative polymers P3 and P5, and this represents an advantage for powder coating.

Preparation of Amorphous Polyesters with OH Groups

### Polyester P6

139.3 g of MPPD (0.84 mol), 138.5 g of NPG (1.33 mol), 112.5 g of TMP (0.84 mol), 325.1 g of IPA (1.96 mol), 122.5 g of ADA (0.84 mol) and 0.4 g of DBTO catalyst are charged to a 2 l four-neck flask fitted with thermometer, inert gas inlet, stirrer and reflux condenser. Under reflux, with a stream of nitrogen being passed through, the mixture of reactants is heated rapidly to 160° C. Water is distilled off continuously. Subsequently the reaction mixture is heated in stages to 230° C. over the course of 3 to 5 h with stirring and with flow of nitrogen, and is stirred further at 230° C. until the polyester P6 has an AN of 10 to 15 mg KOH/g. This gives a branched, amorphous OH-containing polyester P6, whose AN is 14 mg KOH/g. P6 has an OHN of 97 mg KOH/g and a glass transition temperature T_{g} of 30° C. GPC analysis yields the following values: Mₙ=1892 g/mol; D=14.7. P6 has a melt viscosity η₁ of 5.2 Pa*s at 160° C. The solution viscosity η₂ of the polyester P6 at room temperature (P6 solution of 70% NVC and a 5/1 mixture of Solvesso 100™/Solvenon PM™ as solvent) is 48.6 Pa*s (see Table 2).

### Polyesters P7 and P8

The same procedure is carried out as for the preparation of P6, with the composition summarized in Table 2. The characteristic data of the polyesters P7 and P8 are listed in Table 2.

P7 Example 7

P8 Comparative example 8

TABLE 2

| | Composition | | | | | | Characteristic polyester data | | | | | | |
|---|---|---|---|---|---|---|---|---|---|---|---|---|---|
| | | | | | | | AN | OHN | | | | | |
| Poly- | MPPD | CHMPD | NPG | TMP | IPA | ADA | [mg | [mg | Mₙ | | T_{g} | η₁ | η₂ |
| ester | [g] | [g] | [g] | [g] | [g] | [g] | KOH/g] | KOH/g] | [g/mol] | D | [° C.] | [Pa*s] | [Pa*s] |
| P6 | 139.3 | 0 | 138.5 | 112.5 | 325.1 | 122.5 | 14 | 97 | 1892 | 14.7 | 30 | 5.2 | 48.6 |
| P7 | 0 | 193.8 | 185.9 | 150.9 | 436.3 | 164.5 | 14 | 99 | 1978 | 17.0 | 32 | 3.1 | 23.5 |
| P8 | 0 | 0 | 326.6 | 163.9 | 473.9 | 178.6 | 15 | 108 | 2195 | 16.8 | 25 | 6.3 | 41.6 |

### Preparation of Water-Dilutable Polyesters

### Polyester P9

### Stage I—Preparation of the OH-Containing Oligomer

220.7 g of MPPD (1.33 mol), 311.1 g of NPG (2.99 mol), 413.8 g of IPA (2.49 mol) and 0.6 g of DBTO catalyst are charged to a 2 l four-neck flask fitted with thermometer, inert gas inlet, stirrer and reflux condenser. Under reflux, with a stream of nitrogen being passed through, the mixture of reactants is heated rapidly to 160° C. Water is distilled off continuously. Subsequently the reaction mixture is heated in stages to 220° C. over the course of 3 to 5 h with stirring and with flow of nitrogen, and is stirred further at 220° C. until the reaction mixture has an AN of 10 to 15 mg KOH/g. The AN of the oligomer is 12 mg KOH/g.

### Stage II—Preparation of Polymer P9

The oligomer synthesized above is cooled to 160° C. and then 159.6 g of TMSA (0.83 mol) are added. The temperature is raised to 230° C., and condensation is continued under these conditions until the polymer has an AN of 44 to 49 mg KOH/g. The water formed from the polymerization can be stripped off at the end of the reaction by a gentle vacuum, in order to achieve the desired AN. This gives a linear, water-dilutable polyester P9, whose AN is 49 mg KOH/g. P9 has a glass transition temperature T_{g} of 60° C. and a melt viscosity η₁ of 10.7 Pa*s at 160° C. GPC analysis yields the following values: Mₙ=1200 g/mol; D=2.4 (see Table 3).

### Assessment of Resistance of P9 to Hydrolysis

A 20% strength aqueous colloidal solution of P9 is prepared, brought to a pH of 8 using N,N-dimethylethanolamine and stored at 45° C. The time taken for the colloidal solution to undergo precipitation is taken as a measure of the resistance of the polyester to hydrolysis (see Table 4).

### Polyesters P10 and P11

The procedure is the same as for the preparation of P9, with the composition summarized in Table 3. The characteristic data of the polyesters P10 and P11 are listed in Table 3.

P10 Example 10

P11 Comparative example 11

TABLE 3

| | Composition | | | | | Characteristic polyester data | | | | |
|---|---|---|---|---|---|---|---|---|---|---|
| | | | | | | AN | | | | |
| Poly- | MPPD | CHMPD | NPG | IPA | TMA | [mg | Mₙ | | T_{g} | η₁ |
| ester | [g] | [g] | [g] | [g] | [g] | KOH/g] | [g/mol] | D | [° C.] | [Pa · s] |
| P9 | 220.7 | 0 | 311.1 | 413.8 | 159.6 | 49 | 1200 | 2.4 | 60 | 10.7 |
| P10 | 0 | 123.4 | 167.6 | 223.0 | 86.0 | 48 | 1172 | 2.3 | 60 | 8.3 |
| P11 | 0 | 0 | 490.4 | 451.6 | 174.1 | 47 | 1250 | 2.3 | 51 | 3.7 |

TABLE 4

| | Time to precipitation of the aqueous |
|---|---|
| Polyester | solution (days) |
| P9 | >60 days |
| P10 | >60 days |
| P11 | 14 days |

The table above shows that the polyesters P9 and P10 of the invention have particularly high resistance to hydrolysis.

### Preparation of Powder Coating Materials

The reference binder (REF) used is the polyester resin Uralac P-862 (T_{g} 58.0° C., AN 35 mg KOH/g) from DSM Resins B.V. For preparing the powder coating materials PL1 to PL5 and PLR, correspondingly, 570.0 g of powder polyester P1 to P5 or REF are mixed with 30.0 g of commercial curing agent Primid® XL-552 (hydroxyalkylamide from EMS), 300.0 g of titanium dioxide pigment Kronos® 2160 (Kronos), 9.0 g of flow control agent Resiflow® PV5 (Worlée Chemie GmbH) and 2.5 g of benzoin in a universal laboratory mixer (MIT Mischtechnik GmbH), and the mixture is melted and then extruded at 80-100° C. in a twin-screw extruder (MP 19, APV). The extrudate obtained is then coarsely crushed, ground and screened. The resulting powder coating materials PL1 to PL5 and PLR are subjected to the following tests:

| Test parameters | Test method |
|---|---|
| Flow properties | Fluidizability DIN ISO 8130-5 |
| Gel time | DIN ISO8130-6 |

Subsequently the powder coating materials are applied electrostatically to steel test panels (Q-Panel R-36) and baked at 160° C. for 10 minutes. The target film thicknesses are from 60 μm to 80 μm. The resulting coatings are subjected to the following tests:

| Test parameters | Test method |
|---|---|
| Gloss | DIN EN ISO 2813 |
| Impact toughness | EN ISO 6272 |
| Impact sensitivity | ASTM D 2794 |
| Elasticity | EN ISO 1520 |
| Weather stability | Accelerated weathering (QUV-A) DIN EN ISO 11507 |

The results of the coatings tests are summarized in Table 5.

TABLE 5

| | Test parameters | Test method | PL1 | PL2 | PL3 | PL4 | PL5 | PLR |
|---|---|---|---|---|---|---|---|---|
| Powder | Flow properties | Fluidizability | 171.8 | 150.5 | 157.4 | 147.0 | 160.5 | 124.6 |
| coating | Gel time | Gel time at 180° C. [s] | 126 | 127 | 136 | 150 | 131 | 173 |
| material | | | | | | | | |
| Metal test | Gloss | Gloss measurement at 20° | 66 | 82 | 86 | 80 | 79 | 63 |
| panels | Impact toughness | Impact [kg*cm] | 200 | 200 | 200 | 170 | 160 | 200 |
| | Impact sensitivity | Reverse impact [kg*cm] | 30 | 70 | 70 | 10 | 20 | 200 |
| | Elasticity | Erichsen cupping [mm] | 8.4 | 10.2 | 10.4 | 10.3 | 10.0 | 10.6 |
| | Weather stability | Residual gloss after 1000 h QUV-A [%] | 92.0 | 99.0 | 96.0 | 93.7 | 58.0 | 93 |

The powder coating materials PL1, PL2 and PL4 of the invention have very good mechanical properties and high UV stability.

### Preparation of High-Solids 1-Component (1K) Coating Materials

To prepare the high-solids 1K coating materials 1K-PL6, 1K-PL7 and 1K-PL8, 70% strength solutions of the polyesters P6, P7 and P8 in butyl acetate are prepared accordingly. 80 g of each of the 70% strength polyester solutions are mixed with 14 g of commercial curing agent Luwipal® 066 (melamine condensate from BASF), 4 g of n-butanol and 2 g of p-toluenesulfonic acid catalyst. The resulting solutions (NVC 70%) are applied to glass plates and steel test panels using a bar coater. The aim is for film thicknesses of 40 μm to 50 μm. Thereafter the coated test panels are baked at 140° C. for 30 minutes. The resultant coatings are subjected to the following tests:

| | Test parameter | Test method |
|---|---|---|
| Glass | Appearance | visual assessment of surfaces |
| plates | Gloss | DIN EN ISO 2813 |
| | Impact sensitivity | DIN 53157 |
| Steel test | Impact sensitivity | DIN 53157 |
| panels | Elasticity | DIN 53156 |
| | Hydrolysis resistance | Daimler-Chrysler Test PBODCC371 |
| | Chemical resistance | Daimler-Chrysler Test PBODCC371 |

The results of the coatings tests are summarized in Table 6. 1K-PL6 and 1K-PL7 are inventive, 1 K-PL8 serves as a comparative example.

TABLE 6

| | Test parameter | Test method | 1K-PL6 | 1K-PL7 | 1K-PL8 |
|---|---|---|---|---|---|
| Glass plates | Appearance | visual assessment | clear | clear | clear |
| | Gloss | gloss measurement at 20° | 173 | 173 | 175 |
| | Impact sensitivity | pendulum damping (König) [sec.] | 249 | 250 | 232 |
| | | pendulum damping [swings] | 178 | 179 | 166 |
| Steel test | Impact sensitivity | pendulum damping (König) [sec.] | 226 | 256 | 227 |
| panels | | pendulum damping [swings] | 159 | 183 | 164 |
| | Elasticity | Erichsen cupping [mm] | 8.5 | 8.8 | 8.3 |
| | Hydrolysis resistance | Tₘₐₓ [° C.] - distilled water | 68 | 71 | 78 |
| | Chemical resistance | Tₘₐₓ [° C.] - pancreatin in water (50%) | 41 | 42 | 60 |
| | | Tₘₐₓ [° C.] - sulfuric acid (1%) | 41 | 42 | 39 |
| | | Tₘₐₓ [° C.] - sodium hydroxide solution (1%) | 56 | 51 | 53 |

The high-solids coating materials 1 K-PL6 and 1 K-PL7 of the invention exhibit a very good profile of properties. In particular, CHMPD displays an advantage relative to NPG in terms of the mechanical properties on both substrates, glass and steel.

### Preparation of High-Solids 2-Component (2K) Coating Materials

To prepare the high-solids 2K coating materials 2K-PL6, 2K-PL7 and 2K-PL8, 70% strength solutions of the polyesters P6, P7 and P8 in butyl acetate are prepared accordingly. 70 g of each of the 70% strength polyester solutions are mixed with 1 g of solution (10% strength in butyl acetate) of the flow control agent Baysilon® OL17 (polyether from Borchers GmbH), 1 g of dibutyltin dilaurate solution catalyst (5% strength in butyl acetate), 3 g of methoxypropyl acetate, 20 g of commercial curing agent Basonat® HI 190 BS (90% form, polyisocyanate from BASF) and 5 g of butyl acetate. The resulting solutions (NVC 67%) are applied to glass plates and steel test panels using a bar coater. The aim is for film thicknesses of 40 μm to 50 μm. Thereafter the coated test panels are baked at 80° C. for 30 minutes. The resultant coatings are subjected to the following tests:

| | Test parameter | Test method |
|---|---|---|
| Glass | Appearance | visual assessment of surfaces |
| plates | Gloss | DIN EN ISO 2813 |
| | Impact sensitivity | DIN 53157 |
| Steel test | Impact sensitivity | DIN 53157 |
| panels | Elasticity | DIN 53156 |
| | Hydrolysis resistance | Daimler-Chrysler Test PBODCC371 |
| | Chemical resistance | Daimler-Chrysler Test PBODCC371 |

The results of the coatings tests are summarized in Table 7. 2K-PL6 and 2K-PL7 are inventive, 2K-PL8 serves as a comparative example.

TABLE 7

| | Test parameter | Test method | 2K-PL6 | 2K-PL7 | 2K-PL8 |
|---|---|---|---|---|---|
| Glass | Appearance | visual assessment | clear | clear | clear |
| plates | Gloss | gloss measurement at 20° | 168 | 171 | 166 |
| | Impact sensitivity | pendulum damping (König) [sec.] | 196 | 206 | 186 |
| | | pendulum damping [swings] | 140 | 157 | 134 |
| Steel test | Impact sensitivity | pendulum damping (König) [sec.] | 186 | 203 | 186 |
| panels | | pendulum damping [swings] | 133 | 145 | 133 |
| | Elasticity | Erichsen cupping [mm] | 9.8 | 10.0 | 10.3 |
| | Hydrolysis resistance | Tₘₐₓ [° C.] - distilled water | 61 | 61 | 55 |
| | Chemical resistance | Tₘₐₓ [° C.] - pancreatin in water (50%) | 39 | 39 | 39 |
| | | Tₘₐₓ [° C.] - sulfuric acid (1%) | 54 | 55 | 50 |
| | | Tₘₐₓ [° C.] - sodium hydroxide solution (1%) | 51 | 53 | 52 |

The high-solids coating materials 2K-PL6 and 2K-PL7 of the invention are markedly less impact-sensitive than the 2K-PL8 coating material, based on NPG only, and feature high gloss and high resistance to hydrolysis.

1. A polymer obtainable by polycondensation or polyadduct formation from monomeric compounds, wherein use is made as monomeric compound of
substituted 2-aryl-2-alkyl-1,3-propanediols of the formula I or substituted 2-cyclohexyl-2-alkyl-1,3-propanediols of the formula Ia 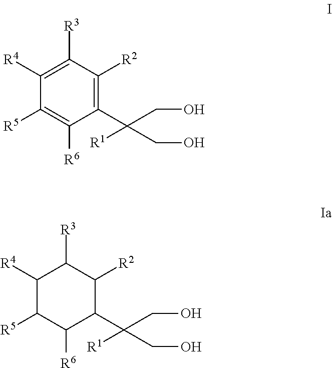
or the alkoxylated derivatives of the compounds of the formulae I and Ia, where R¹ is a linear or branched alkyl group having 1 to 10 C atoms and R² to R⁶ independently of one another are selected from the group consisting of hydrogen, methyl-, ethyl-, propyl-, isopropyl-, n-butyl-, and tert-butyl-.

2. The polymer according to claim 1, wherein use is made as monomeric compound or its alkoxylated derivatives of the formula I or of the formula Ia of those for which R¹ is linear alkyl groups having 1 to 4 C atoms and R² to R⁶ is hydrogen.

3. The polymer according to either of claims 1 and 2, wherein the compounds of the formula I or of the formula Ia are obtainable by reacting aldehydes of the formula II or of the formula IIa 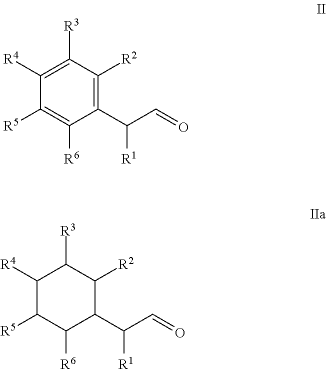
where R¹ and R² to R⁶ have the preceding definitions with formaldehyde in an aldol-Cannizzaro reaction or in an aldol condensation with subsequent hydrogenation.

4. The polymer according to either of claims 1 and 2, wherein the compounds of the formula Ia are obtainable by hydrogenating corresponding, identically substituted compounds of the formula I, with R¹ and R² to R⁶ having the preceding definition.

5. The polymer according to any of claims 1 to 4, which is a polyester.

6. The polymer according to any of claims 1 to 5, which is a polycarbonatediol (obtainable by reacting dialkyl carbonates or cyclic carbonates with diols, with elimination of alcohol).

7. The polymer according to any of claims 1 to 6, which is a polyurethane.

8. The polymer according to any of claims 1 to 7, which is a polyadduct which is obtainable by ring-opening addition polymerization of lactones or lactams.

9. The use of the polymer according to any of claims 1 to 8 for preparing a thermoplastic composition.

10. A thermoplastic composition comprising a polymer and/or repeat units of a polymer according to any of claims 1 to 8.

11. The use of the thermoplastic composition according to claim 10 for producing a shaped article.

12. The use of the polymer according to any of claims 1 to 8 for producing a coating material, sealant or adhesive.

13. A coating material, sealant or adhesive comprising repeat units of a polymer according to any of claims 1 to 8.

14. The coating material, sealant or adhesive according to claim 13, which is an aqueous material.

15. The use of the polymer according to any of claims 1 to 8 for producing a powder coating material.

16. A powder coating material comprising repeat units of a polymer according to any of claims 1 to 8.

17. The use of the polymer according to any of claims 1 to 8 for producing a radiation-curable coating material.

18. A radiation-curable coating material comprising repeat units of a polymer according to any of claims 1 to 8.
